(19) United States
(12) Patent Application Publication
(10) Pub. No.: US 2010/0315304 A1
(43) Pub. Date: Dec. 16, 2010

(54) SLOT ANTENNA AND SLOT ANTENNA ARRAY

(75) Inventor: HSIN-LUNG TU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/730,251

(22) Filed: Mar. 24, 2010

(30) Foreign Application Priority Data
Jun. 16, 2009 (CN) 200910303306.3

(51) Int. Cl. H01Q 13/10

(52) U.S. Cl. 343/770

(57) ABSTRACT

A slot antenna disposed on a substrate including a first surface and an opposite second surface includes a feeding portion, a first radiation portion, a second radiation portion, and a third radiation portion. The feeding portion is disposed on the first surface, and operable to feed electromagnetic signals. The first radiation portion electronically connected to the feeding portion is circular-shaped and disposed on the first surface. The second radiating portion is disposed on the second surface and defines a slot. The second radiation portion couples the first radiation portion to radiate the electromagnetic signals. The third radiation portion is ring-shaped and disposed on the second surface. The third radiation portion couples the first radiation portion to radiate the electromagnetic signals. The first radiation portion, the second radiation portion, and the third radiation portion respectively radiate electromagnetic signals with different frequencies. The second radiation portion is grounded.

### BACKGROUND

1. Technical Field

Embodiments of the present disclosure relate to antennas, and more particularly to a slot antenna and a slot antenna array.

2. Description of Related Art

In the field of wireless communication, slot antennas are used for only one single frequency band and have a very narrow impedance bandwidth with a return loss of about −10 dB. An assortment of slot antennas must be used to cover different frequency bands and expand the impedance bandwidth in a single application, which increases cost of the application. Therefore, it is desirable to design a slot antenna that covers different frequency bands and has good radiation patterns.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a plan view of one embodiment of a slot antenna array of the present disclosure;

FIG. 2 is an inverted view of one embodiment of a slot antenna array of the present disclosure;

FIG. 3 is a stereogram view of one embodiment of a slot antenna array of the present disclosure;

FIG. 4 illustrates dimensions of one embodiment of a slot antenna of the present disclosure;

FIG. 5 is a graph showing an exemplary radiation pattern of the slot antenna array of FIG. 3; and

FIG. 6 is a graph showing an exemplary return loss of the slot antenna array of FIG. 3.

### DETAILED DESCRIPTION

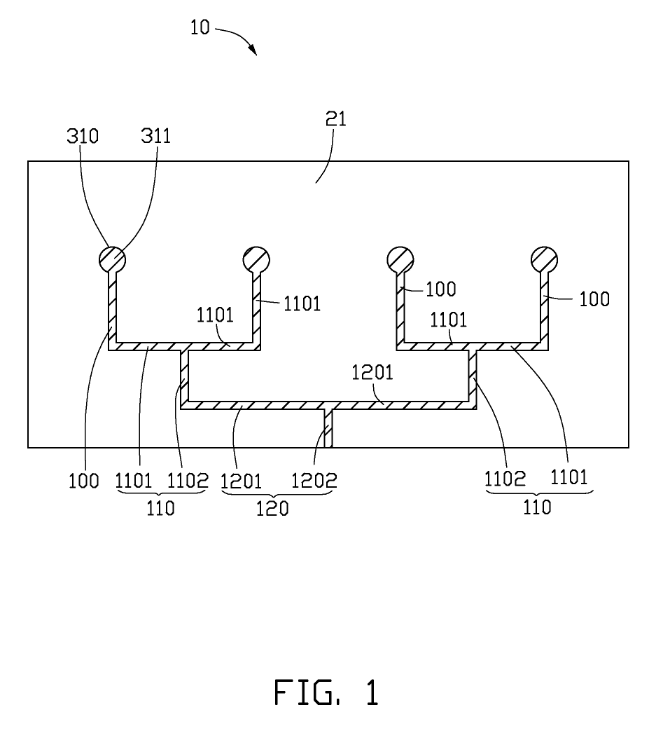

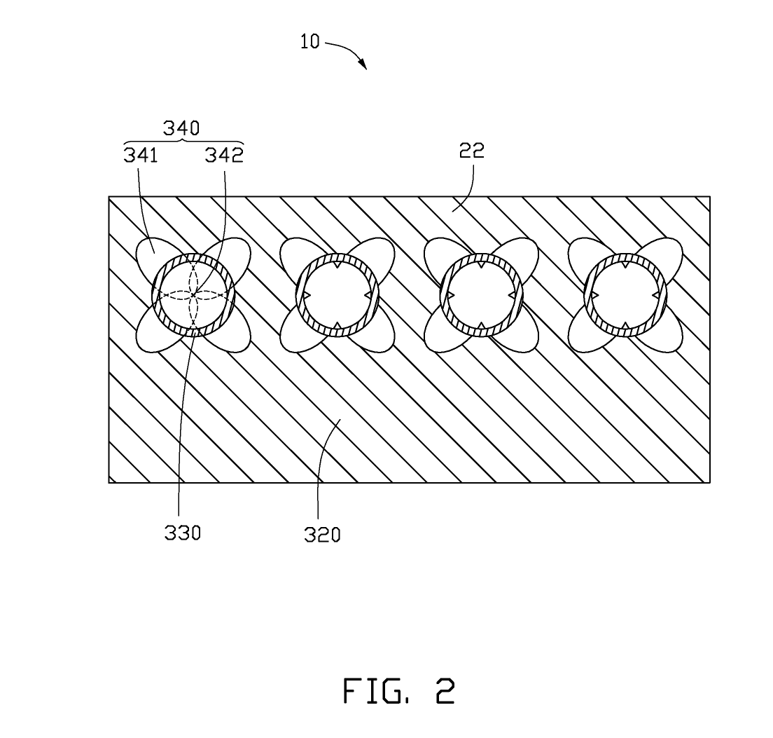

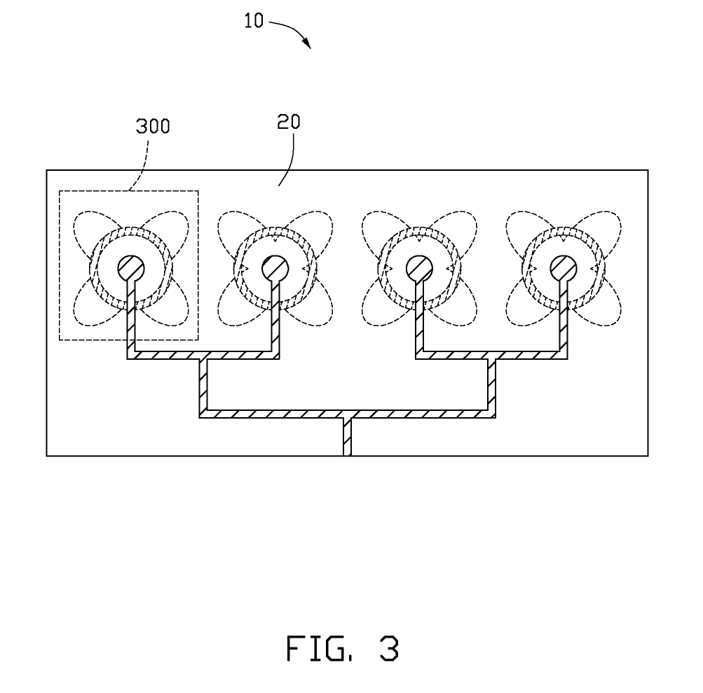

FIG. 1, FIG. 2 and FIG. 3 are a plan view, an inverted view, and a stereogram view of one embodiment of a slot antenna array 10 of the present disclosure, respectively. As shown, the slot antenna array 10 is located on a substrate 20 including a first surface 21 and a second surface 22 opposite to the first surface 21.

In one embodiment, the slot antenna array 10 comprises a plurality of slot antennas 300 and a plurality of first extra feeding lines 110.

In one embodiment, each slot antenna 300 comprises a feeding portion 100, a first radiation portion 310, a second radiation portion 320, and a third radiation portion 330.

In one embodiment, the slot antenna array 10 comprises four slot antennas 300 and two first extra feeding lines 110.

In one embodiment, the feeding portion 100 is located on the first surface 21, to feed electromagnetic signals.

The first radiation portion 310 is circular-shaped and is located on the first surface 21, and connected to the feeding portion 100. In one embodiment, centers 311 of all the first radiation portions 310 are arranged along a line.

The second radiation portion 320 is located on the second surface 22 and grounded. In one embodiment, the second radiation portion 320 defines a slot 340 corresponding to the first radiation portion 310 and couples with the first radiation portion 310 to radiate electromagnetic signals. In one embodiment, the frequencies of the electromagnetic signals include a first resonant frequency and a second resonant frequency, and the second resonant frequency is twice of the first resonant frequency.

In one embodiment, the slot 340 includes four interconnected elliptical slot 341 having about the same size. One end of the major axes of each elliptical slot 341 intersects at one point 342, and the slot 340 is centro-symmetric in relation to the point 342. In other words, the slot 340 combines the four elliptical slots 341 into a star-shaped. In one embodiment, a center 311 of the first radiation portion 310 is opposite to the point 342.

The third radiation portion 330 is ring-shaped and located on the second surface 22. In one embodiment, the projection of the center 311 of the first radiation portion 310 on the second surface 22 laps over a center of the third radiation portion 330, and the third radiation portion 330 couples with the first radiating portion 310 to radiate the electromagnetic signals.

In one embodiment, the center of each elliptical slot 341 is located in the third radiation portion 330. In one embodiment, a length of an outer radius of the third radiation portion 330 is not less than half a length of the main axes of the elliptical slot 341. Thus, the third radiation portion 330 can change the second resonant frequency. Therefore, the slot antenna 300 can cover different frequency bands. In one embodiment, the frequency of electromagnetic signals radiated by the third radiation portion 330 is about 1.5 times the first resonant frequency.

The plurality of first extra feeding lines 110 are connected to the feeding portions 100 of the slot antennas 300, to feed electromagnetic signals. In one embodiment, the slot antenna array 10 includes two first extra feeding lines 110. Each first extra feeding line 110 connects to the feeding portions 100 of two adjacent slot antennas 300. In one embodiment, each first extra feeding line 110 is T-shaped and includes a first feeding line 1101 and a second feeding line 1102. The first feeding line 1101 is perpendicularly connected to the second feeding line 1102. The feeding portions 100 of two adjacent slot antennas 300 connect to two ends of the first feeding line 1101, respectively.

In one embodiment, the slot antenna array 10 further comprises a second extra feeding line 120. The second extra feeding line 120 has a T-shape. In one embodiment, the second extra feeding line 120 includes a third feeding line 1201 and a fourth feeding line 1202. The fourth feeding line 1202 is perpendicularly connected to the third feeding line 1201. The two second feeding lines 1102 connect to two ends of the third feeding line 1201, respectively.

The first extra feeding line 110 and the second extra feeding line 120 have the same shape, thus the slot antennas 300 can radiate signals which have the same phase.

In other embodiments, the slot antenna array 10 may further comprise more slot antennas 300 and more first extra feeding lines 110. Therefore, a side lobe level can be restrained, and the slot antenna array 10 has a better performance.

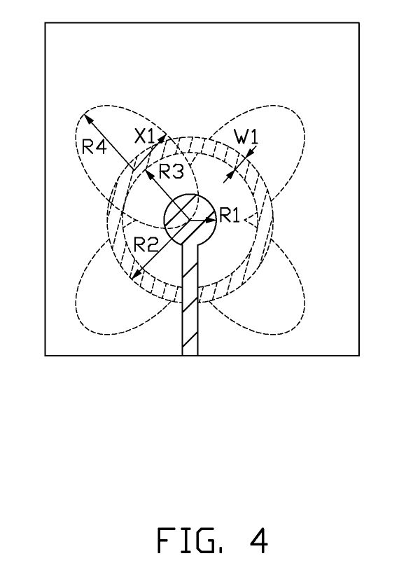

FIG. 4 illustrates dimensions of a slot antenna 300. In one embodiment, the radius R1 of the first radiation portion 310 of the slot antenna 300 is 7 mm. The first frequency radiated by the first radiation portion 310 is F1, a wavelength of signal with the first frequency F1 is equal to length of a perimeter of the first radiation portion 310, namely 2πR1(14 πmm). In one embodiment, a half length of the main length (R4) of the elliptical slot 341 is 7 mm, and a half length of the secondary axes (X1) of the elliptical slot 341 is 2.5 mm. In one embodiment, the frequencies of electromagnetic signals radiated by the second radiation portion 320 include a first resonant frequency F2 and a second resonant frequency F3. A wavelength of the first resonant frequency F2 is half of the perimeter of the slot 340. The second resonant frequency F3 is two times of the first resonant frequency F2.

In one embodiment, the outer radius R2 of the third radiation portion 330 is 11 mm, and the inside radius R3 of the radiation portion 330 is 10 mm. The third radiation portion 330 changes the second resonant frequency F3 to around 1.5 times F2. In other embodiments, R1, R4 and X1 can be other lengths according to the wireless communication standard and frequency bands of the use needs. Thus the slot antenna array 10 can cover different frequency bands with better radiation.

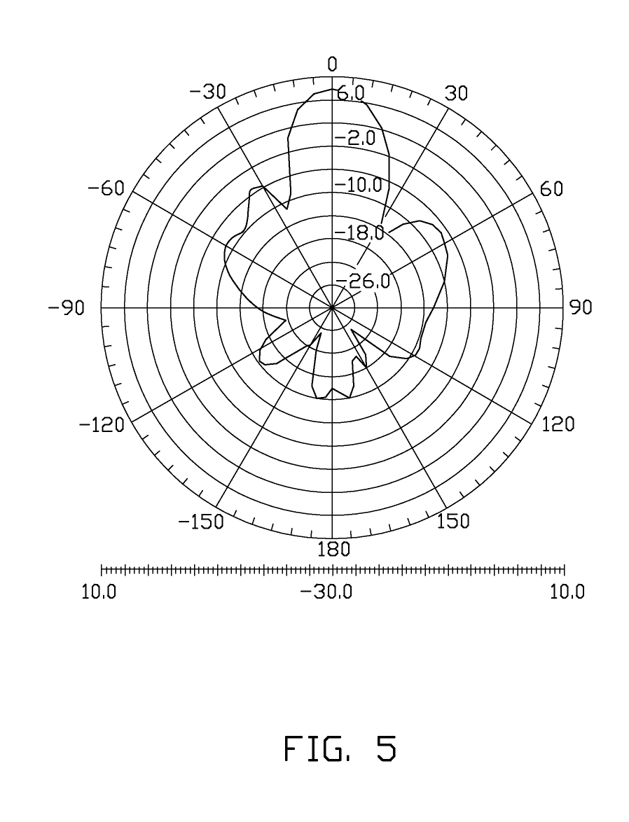

FIG. 5 is a graph showing an exemplary radiation pattern of the slot antenna array 100. As shown, the main lobe width of the slot antenna array 10 is narrower, and the side lobe level of the slot antenna array 10 is weak. Therefore the slot antenna array 10 has a good radiation pattern. In other embodiments, a grounded reflector can be added to the top of the first surface 21 causing the main radiation pattern form toward one direction, thus the slot antenna array 10 can have a desired signal radiation pattern.

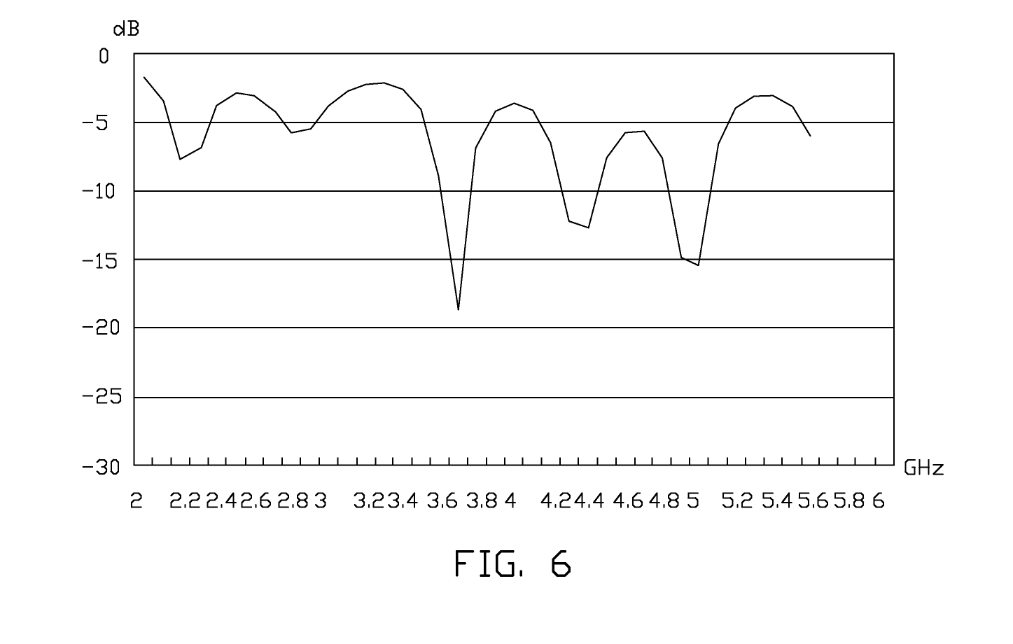

FIG. 6 is a graph showing an exemplary return loss of the slot antenna array. As shown, frequency bands with a return loss less than −10 dB are 3.6 GHz˜3.8 GHz, 4.3 GHz˜4.5 GHz and 4.8 GHz˜5.1 GHz, that is, a high frequency (fH) and a low frequency (fL) is known, and a center frequency (fc) is equal to (fL+(fH-fL)/2). Accordingly, impedance bandwidth (BW) is equal to (fH-fL)/fc. Therefore the slot antenna array 10 has three center frequencies and three bandwidths.

In the present disclosure, the slot antenna 300 and the slot antenna array 10 cover different frequency bands with better radiation patterns by defining the slot 340 in the second radiation portion 320, and designing the ring-shaped third radiation portion 330 in the slot 340.

While various embodiments and methods of the present disclosure have been described, it should be understood that they have been presented by example only and not by limitation. Thus the breadth and scope of the present disclosure should not be limited by the above-described embodiments, but should be defined only in accordance with the following claims and their equivalents.

What is claimed is:

1. A slot antenna located on a substrate including a first surface and a second surface opposite to the first surface, the slot antenna comprising:
a feeding portion located on the first surface of the substrate, to feed electromagnetic signals;
a first radiation portion being circular-shape and located on the first surface, and connected to the feeding portion;
a second radiation portion located on the second surface and coupling with the first radiating portion to radiate the electromagnetic signals, the second radiation portion being grounded and defining a slot corresponding to the first radiation portion; and
a third radiation portion being ring-shaped and located on the second surface, wherein a center of the first radiation portion is opposites to a center of the third radiation portion, and the third radiation portion couples with the first radiating portion to radiate the electromagnetic signals;
wherein the first radiation portion, the second radiation portion, and the third radiation portion respectively radiate electromagnetic signals of different frequencies.

2. The slot antenna as claimed in claim 1, wherein the slot is formed with four interconnected elliptical slots with same size.

3. The slot antenna as claimed in claim 2, wherein one ends of major axes of the four elliptical slots are connected at one point, and the slot is centro-symmetric in relation to the one point.

4. The slot antenna as claimed in claim 3, wherein the center of each elliptical slot is located on the third radiation portion.

5. The slot antenna as claimed in claim 4, wherein a difference between outer and inner radiuses of the third radiation portion is substantially 1 mm.

6. A slot antenna array located on a substrate including a first surface and a second surface opposite to the first surface, the slot antenna array comprising:
a plurality of slot antennas, each of the slot antennas comprising:
a feeding portion located on the first surface of the substrate, to feed electromagnetic signals;
a first radiation portion being circular-shaped located on the first surface, and connected to the feeding portion;
a second radiation portion located on the second surface and coupling with the first radiating portion to radiate the electromagnetic signals, the second radiation portion being grounded and defining a slot corresponding to the first radiation portion; and
a third radiation portion being ring-shaped located on the second surface, wherein a center of the first radiation portion is opposites to a center of the third radiation portion, and the third radiation portion couples with the first radiating portion to radiate the electromagnetic signals;
wherein the first radiation portion, the second radiation portion, and the third radiation portion respectively radiate electromagnetic signals of different frequencies; and
a plurality of first extra feeding lines connected to the feeding portions of the plurality of slot antennas to feed electromagnetic signals.

7. The slot antenna array as claimed in claim 6, wherein the slot is formed with four interconnected elliptical slots with same size.

8. The slot antenna array as claimed in claim 7, wherein one ends of major axes of the four elliptical slots are connected at one point, and the slot is centro-symmetric in relation to the one point.

9. The slot antenna array as claimed in claim 7, wherein a center of each elliptical slot is located on the third radiation portion.

10. The slot antenna array as claimed in claim 9, wherein a difference between outer and inner radiuses of the third radiation portion is substantially 1 mm.

11. The slot antenna array as claimed in claim 6, centers of the first radiation portions of the plurality of slot antennas are arranged along a line.

12. The slot antenna array as claimed in claim 11, wherein each first extra feeding line has a T-shape.

13. The slot antenna array as claimed in claim 12, wherein the slot antenna array further comprises a second extra feeding line connected to the plurality of first extra feeding lines to feed electromagnetic signals.
